(19) United States
(12) Patent Application Publication
(10) Pub. No.: US 2006/0177637 A1
(43) Pub. Date: Aug. 10, 2006

(54) Color ID card, card making system, method, and program, and storage medium

(75) Inventor: Seiji Kimura, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/351,207

(22) Filed: Feb. 9, 2006

(30) Foreign Application Priority Data
Feb. 10, 2005 (JP) 2005-034641
Nov. 16, 2005 (JP) 2005-331793

(51) Int. Cl. B44C 1/17

(52) U.S. Cl. 428/195.1

(57) ABSTRACT

A color ID card for color matching that includes: a matching card; and a to-be-matched card for color matching with the matching card. Wherein, the matching card and the to-be-matched card are both printed with a color ID pattern that is a combination of colors corresponding to, on a digit basis, an identification number of identifying a matching object.

### BACKGROUND

1. Technical Field

The present invention relates to a color ID card, a card making system, method, and program, and a storage medium, all of which are for color matching using color information.

2. Related Art

In recent years, various types of medical malpractices are frequently occurring in hospitals, including improper medication such as injection. Such improper medication is a medical malpractice of giving pharmaceutical drugs to patients who are not supposed to be given such drugs. As a measure against such a medical malpractice, there is a system of checking the match between a patient ID and matching information for the purpose of making sure that a pharmaceutical drug about to be given to the patient is correctly right for him or her. The patient ID is assigned to the patient for his or her identification, and the matching information is used for verification with the patient ID. Such patient ID and matching information are both printed with barcode, and prior to medical treatment, the patient ID is checked against the matching information by using a barcode reader. The problem with such a system is that nurses have to carry all the time the barcode reader, thereby putting significant burden thereon. For betterment, Patent Document 1 (JP-A-2003-6332) describes a system of creating labels of graphics or color graphics for identification use of patients to check the match between the patients and pharmaceutical drugs.

The issue here is that the labels of Patent Document 1 are using patient attributes as a basis to create color graphics, e.g., patient blood type, department in charge, or infectious disease type (refer to FIG. 2 in document). It means if patients share the same attributes, the resulting labels are of the same color graphics, thereby resulting in erroneous matching.

### SUMMARY

An advantage of some aspects of the invention is to provide a color ID card, a card making system, method, and program, and a storage medium, all of which enable matching in a simple manner with less error.

A first aspect of the invention is directed to a color ID card for color matching, including: a matching card; and a to-be-matched card for color matching with the matching card. The matching card and the to-be-matched card are both printed with a color ID pattern that is a combination of colors corresponding to, on a digit basis, an identification number of identifying a matching object.

Such a configuration favorably reduces the possible occurrence of any erroneous matching as a consequence of making matching using a color ID pattern being a combination of colors corresponding to an identification number on a digit basis. That is, the identification number is unique to its corresponding object for matching (matching object), and the identification number is used as a basis to create a color ID pattern. In this sense, the resulting ID pattern will never share the same color combination with any other objects. The “matching object” here may be either person or object. For a matching with a person as a matching object, his or her identification number is to be used as a basis to create a color ID pattern, and for a matching with an object as a matching object, the identification number assigned thereto is used as a basis to create a color ID pattern. The resulting color ID patterns thus have each unique color combination, and utilizing such color ID patterns can preferably reduce the possible occurrence of any erroneous matching. This configuration is surely not requiring any additional equipment such as barcode reader for use for matching, thereby enabling a matching in a simple manner.

The color ID card may be of alternative configuration in which the color ID pattern of the matching card is of a symmetrical design with the color ID pattern of the to-be-matched card.

This configuration enables matching not only based on color combination but also based on whether graphics patterns are the same or not. This is as a consequence of the color ID pattern of the matching card being of a symmetrical design with the color ID pattern of the to-be-matched card, thereby favorably reducing any erroneous matching to a further degree.

The color ID card may be of still alternative configuration in which at least either the matching card or the to-be-matched card is printed frameless with the color ID pattern on the end surface.

This configuration enables matching with two color ID patterns closer to each other. This is as a consequence of at least either the matching card or the to-be-matched card being printed frameless with the color ID pattern on the end surface. That is, if the color ID patterns are printed inside of the cards, matching has to be made with some space between the cards, i.e., between the color ID patterns. With this being the case, the color ID patterns may be misaligned, and the matching may end up being erroneous. On the other hand, if at least either of the cards is printed frameless with the color ID pattern on the end surface as in this configuration, the card can be placed over the remaining card so that their color ID patterns can be brought closer to each other for matching. This thus favorably reduces the possible occurrence of any erroneous matching.

The color ID card may be of still alternative configuration in which the matching card and the to-be-matched card are each flat and linear on the mating end surface printed with the color ID pattern, and are each not flat and linear on the end surface opposite to the mating end surface.

This configuration enables to preclude the possibility of making matching with the wrong color ID pattern orientation. That is, with this configuration, the color ID patterns are aligned together with their mating end surfaces being flat and linear prior to color check. This thus favorably reduces the possible occurrence of any erroneous matching.

The color ID card may be of still alternative configuration in which the color ID pattern is formed using two or more of a graphics pattern varying in width by the digits of the identification number.

This configuration enables to preclude the possibility of erroneously making matching that is often caused by similar graphics patterns between the matching and to-be-matched cards. This is as a consequence of the color ID pattern being formed using two or more of a graphics pattern varying in width.

The color ID card may be of still alternative configuration in which the color ID pattern is of the combination of the colors showing no similarity in lightness and chroma among the digits of the identification number.

This configuration enables to reduce the possible occurrence of any erroneous matching resulted from wrong color discrimination. This is as a consequence of the color combination being easy for color discrimination in terms of category even for people suffering from color perception difficulty.

The color ID card may be of still alternative configuration in which the color ID pattern is of the combination of the colors showing a similarity in hue but not in lightness among the digits of the identification number.

This configuration also enables to reduce the possible occurrence of any erroneous matching resulted from wrong color discrimination. This is as a consequence of the color combination being easy for color discrimination in terms of category even for people suffering from color perception difficulty.

The color ID card may be of still alternative configuration in which the color ID pattern includes a matching pattern being a combination of colors corresponding to the identification number on a digit basis, and a positioning pattern for use for positioning the matching pattern between the matching card and the to-be-matched card.

This configuration enables to position the matching patterns printed to both the matching and to-be-matched cards using the positioning pattern, thereby favorably reducing the possible occurrence of any erroneous matching.

The color ID card may be of still alternative configuration in which the matching card and the to-be-matched card are each printed with a picture for use to check the matching object.

This configuration enables matching check not only based on the color ID patterns but also based on pictures, thereby favorably reducing any erroneous matching.

The color ID card may be of still alternative configuration in which the matching card and the to-be-matched card are each created with, as a printing medium, a label sheet having an adhesive sticker surface.

This configuration offers greater versatility to the matching and to-be-matched cards printed with the color ID patterns. This is as a consequence of creating the cards as labels with adhesive sticker surfaces so that, for example in hospitals, the matching label may be affixed to a patient name card, and the to-be-matched label may be affixed to his or her drug package, for example.

The color ID card may be of still alternative configuration in which either the matching card and the to-be-matched card is formed with a notch portion, a remaining of the cards is formed with a convex portion that can be inserted into the notch portion, and the color ID pattern is printed on a coupled part of the cards between the notch portion and the convex portion.

This configuration enables to position the color ID patterns correctly at their matching positions by coupling the cards together, i.e., the convex portion of one of the cards is inserted into the notch portion of the remaining card. This considerably reduces the possible occurrence of any erroneous matching resulted from misaligned matching positions, and favorably eases the procedure for matching.

The color ID card may be of still alternative configuration in which either the matching card or the to-be-matched card is formed with, at a printing part for the color ID pattern, an aperture window to make visible the color ID pattern printed on the remaining of the cards.

This configuration enables matching with one of the cards placed over the other, i.e., the color ID pattern of one of the cards is faced to the aperture window formed to the other card.

The color ID card may be of still alternative configuration in which either the matching card or the to-be-matched card is notched at one end in the width direction toward inside to form a notch window, and the color ID pattern is printed frameless on the end surface of the notch window.

This configuration also enables matching with one of the cards placed over the other, i.e., the color ID pattern of one of the cards is faced to the notch window formed to the other card at one end.

The color card may be of still alternative configuration in which the matching card and the to-be-matched card are each formed with a notch portion to align the cards with each other to enable matching using the color ID patterns.

This configuration enables to position the color ID patterns correctly at their matching positions with positioning of the cards by aligning their notch portions together. This considerably reduces the possible occurrence of any erroneous matching resulted from misaligned matching positions, and favorably eases the procedure for matching.

A second aspect of the invention is directed to a card making system that makes a color ID card including a matching card and a to-be-matched card for color matching with the matching card. The system includes: a unit that sets a color, on a digit basis, to an identification number of identifying a matching object; a unit that sets a graphics pattern to each of the digits of the identification number; a unit that forms a color ID pattern by combining the colors and the graphics patterns set to each of the digits of the identification number, and creates image data of the color ID card by laying out the color ID pattern to both the matching card and the to-be-matched card; a unit that converts the image data into printing data; and a unit that prints the color ID card onto a predetermined printing medium based on the printing data.

Such a system favorably reduces the possible occurrence of any erroneous matching as a consequence of making matching using a color ID pattern being a combination of colors and graphics patterns corresponding to an identification number on a digit basis. That is, the identification number is unique to its corresponding object for matching (matching object), and the identification number is used as a basis to create a color ID pattern. In this sense, the resulting color ID pattern will never share the same color combination with any other objects. The resulting color ID patterns thus have each unique color combination, and utilizing such color ID patterns can favorably reduce the possible occurrence of any erroneous matching. This configuration is surely not requiring any additional equipment such as barcode reader for use for matching, thereby enabling a matching in a simple manner.

The card making system may be of alternative configuration in which the color ID pattern includes a matching pattern being a combination of the colors set to each of the digits of the identification number, and a positioning pattern for use for positioning the matching pattern between the matching card and the to-be-matched card, and the graphics pattern setting unit sets both the matching pattern and the positioning pattern.

This configuration enables to position the matching patterns printed to both the matching and to-be-matched cards using the positioning pattern, thereby favorably reducing the possible occurrence of any erroneous matching.

A third aspect of the invention is directed to a card making method for making a color ID card including a matching card and a to-be-matched card for color matching with the matching card. The method includes: setting a color, on a digit basis, to an identification number of identifying a matching object; setting a graphics pattern to each of the digits of the identification number; forming a color ID pattern by combining the colors and the graphics patterns set to each of the digits of the identification number, and creating image data of the color ID card by laying out the color ID pattern to both the matching card and the to-be-matched card; converting the image data into printing data; and printing the color ID card onto a predetermined printing medium based on the printing data.

Such a method favorably reduces the possible occurrence of any erroneous matching as a consequence of making matching using a color ID pattern being a combination of colors and graphics patterns corresponding to an identification number on a digit basis. That is, the identification number is unique to its corresponding object for matching (matching object), and the identification number is used as a basis to create a color ID pattern. In this sense, the resulting color ID pattern will never share the same color combination with any other objects. The resulting color ID patterns thus have each unique color combination, and utilizing such color ID patterns can favorably reduce the possible occurrence of any erroneous matching. This configuration is surely not requiring any additional equipment such as barcode reader for use for matching, thereby enabling a matching in a simple manner.

A fourth aspect of the invention is directed to a computer-executable program for making a color ID card including a matching card and a to-be-matched card for color matching with the matching card. The program includes, for computer execution: a process of setting a color, on a digit basis, to an identification number of identifying a matching object; a process of setting a graphics pattern to each of the digits of the identification number; and a process of forming a color ID pattern by combining the colors and the graphics patterns set to each of the digits of the identification number, and creating image data of the color ID card by laying out the color ID pattern to both the matching card and the to-be-matched card.

Such a program favorably reduces the possible occurrence of any erroneous matching as a consequence of making matching using a color ID pattern being a combination of colors and graphics patterns corresponding to an identification number on a digit basis. That is, the identification number is unique to its corresponding object for matching (matching object), and the identification number is used as a basis to create a color ID pattern. In this sense, the resulting color ID pattern will never share the same color combination with any other objects. The resulting color ID patterns thus have each unique color combination, and utilizing such color ID patterns can favorably reduce the possible occurrence of any erroneous matching. This configuration is surely not requiring any additional equipment such as barcode reader for use for matching, thereby enabling a matching in a simple manner.

A fifth aspect of the invention is directed to a storage medium that stores a computer-executable program for making a color ID card including a matching card and a to-be-matched card for color matching with the matching card. The program includes, for computer execution: a process of setting a color, on a digit basis, to an identification number of identifying a matching object; a process of setting a graphics pattern to each of the digits of the identification number; and a process of forming a color ID pattern by combining the colors and the graphics patterns set to each of the digits of the identification number, and creating image data of the color ID card by laying out the color ID pattern to both the matching card and the to-be-matched card.

Such a program provided in a storage medium favorably reduces the possible occurrence of any erroneous matching as a consequence of making matching using a color ID pattern being a combination of colors and graphics patterns corresponding to an identification number on a digit basis. That is, the identification number is unique to its corresponding object for matching (matching object), and the identification number is used as a basis to create a color ID pattern. In this sense, the resulting color ID pattern will never share the same color combination with any other objects. The resulting color ID patterns thus have each unique color combination, and utilizing such color ID patterns can favorably reduce the possible occurrence of any erroneous matching. This configuration is surely not requiring any additional equipment such as barcode reader for use for matching, thereby enabling a matching in a simple manner.

### BRIEF DESCRIPTION OF THE DRAWINGS

The invention will be described with reference to the accompanying drawings, wherein like numbers reference like elements.

FIG. 1 is a schematic diagram showing the configuration of a card making system.

FIG. 2 is a conceptual view of patient data.

FIGS. 3A to 3C are each a schematic diagram showing an exemplary matching pattern.

FIGS. 4A and 4B are each a schematic diagram showing an exemplary positioning pattern.

FIG. 5 is a schematic block diagram showing the hardware configuration of a terminal.

FIG. 6 is a schematic block diagram showing the hardware configuration of a management server.

FIG. 7 is a conceptual view of a color setting register.

FIG. 8 is a conceptual view of a pattern setting register.

FIG. 9 is a flowchart of a card making process.

FIG. 10 is a schematic diagram showing a color ID card (application example of label sheet) of a first embodiment.

FIG. 11 is a schematic diagram showing a usage example of the color ID card of the first embodiment.

FIG. 12 is a schematic diagram showing a color ID pattern of a modified example 2 in the first embodiment.

FIG. 13 is a schematic diagram showing a color ID pattern of a modified example 3 in the first embodiment.

FIG. 14 is a schematic diagram showing a color ID pattern of a modified example 4 in the first embodiment.

FIG. 15 is a schematic diagram showing a color ID card of a second embodiment.

FIG. 16 is a schematic diagram showing the use condition of the color ID card of the second embodiment.

FIG. 17 is a schematic diagram showing a color ID card of a third embodiment.

FIG. 18 is a schematic diagram showing the use condition of the color ID card of the third embodiment.

FIG. 19 is a schematic diagram showing a color ID card of a fourth embodiment.

FIG. 20 is a schematic diagram showing the use condition of the color ID card of the fourth embodiment.

FIG. 21 is a schematic diagram showing a color ID card of a fifth embodiment.

FIG. 22 is a schematic diagram showing the use condition of the color ID card of the fifth embodiment.

### DESCRIPTION OF EXEMPLARY EMBODIMENTS

### First Embodiment

By referring to the accompanying drawings, described now is a first embodiment of the invention that is embodied as a color ID card that is available for use for identifying patients in hospitals, for example.

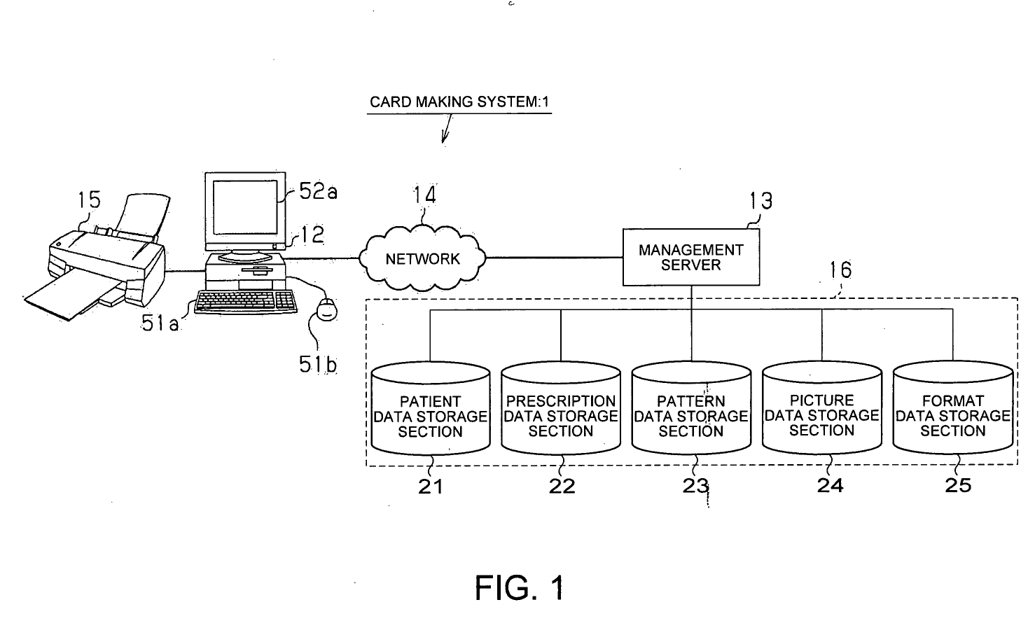

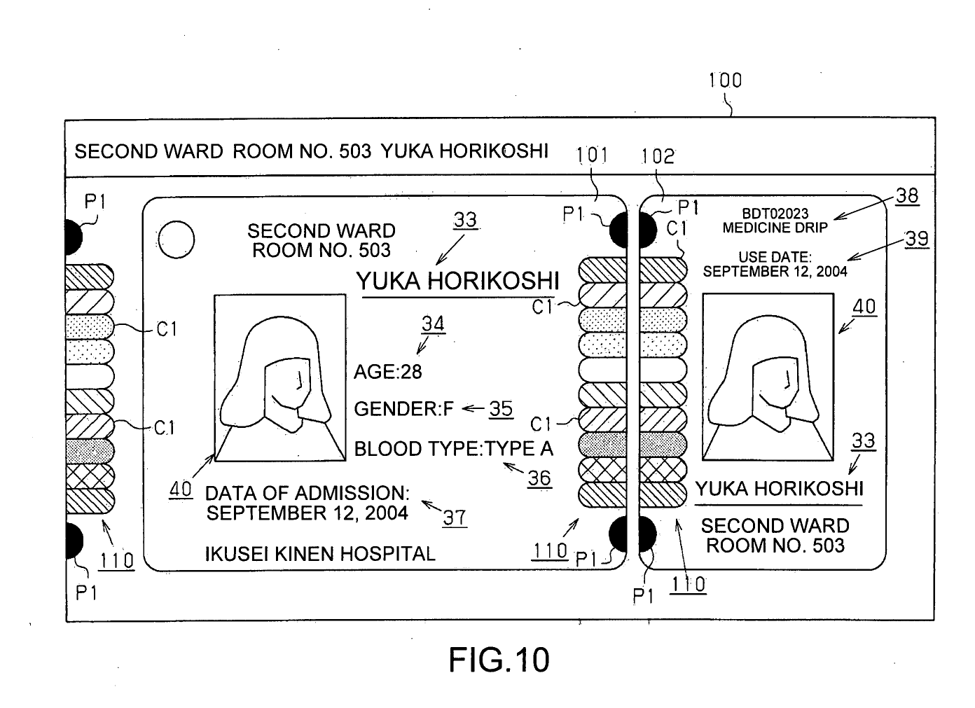

FIG. 1 is a schematic diagram showing a card making system 1 of this embodiment. Using a computer database, the card making system 1, i.e., computer system, serves to make color ID cards 101 and 102 (refer to FIG. 10) that will be described later, and manage various types of data. In this example, the system is configured based on the relational data model of a client/server system.

The card making system 1 is provided with a terminal 12, and a management server 13. The terminal 12 serves as a client computer that is placed inside of a hospital, and the management server 13 serves as a server computer. The terminal 12 and the management server 13 are connected to each other over a network 14, e.g., LAN.

The management server 13 is provided with integrative server functions, e.g., Web server or FTP server. The data exchange between the management server 13 and the terminal 12 is performed in accordance with any predetermined communications protocol, e.g., TCP/IP. Note in this example that the server functions are entirely integrated into a piece of management server 13, but this is surely not the only option in terms of decentralization and integration of server functions. Alternatively, the server functions may be organized by any predetermined unit, e.g., the server functions may be entirely or partially decentralized or integrated functionally or physically depending on the load or others.

The terminal 12 is exemplified by a personal computer or others, and is connected with a printer 15 exemplified by a color inkjet printer. In this example, the printer 15 prints the two color ID cards 101 and 102 on any predetermined printing medium, e.g., a label sheet 100 (refer to FIG. 10) having an adhesive sticker surface in this example. The color ID card 101 serves as a matching card, and the color ID card 102 serves as a to-be-matched card, and such printing is performed based on printing data to be created by the terminal 12. A description about the printing data will be given later. Although FIG. 1 shows a piece of terminal 12, the terminal 12 is plurally placed inside of the hospital.

The management server 13 is connected with a database 16, which is storing various types of data needed to create the color ID cards 101 and 102. This database 16 is configured to include a patient data storage section 21, a prescription data storage section 22, a pattern data storage section 23, a picture data storage section 24, and a format data storage section 25. In this example, although the database 16 is decentralized into the storage sections 21 to 25 by function, this is not the only option.

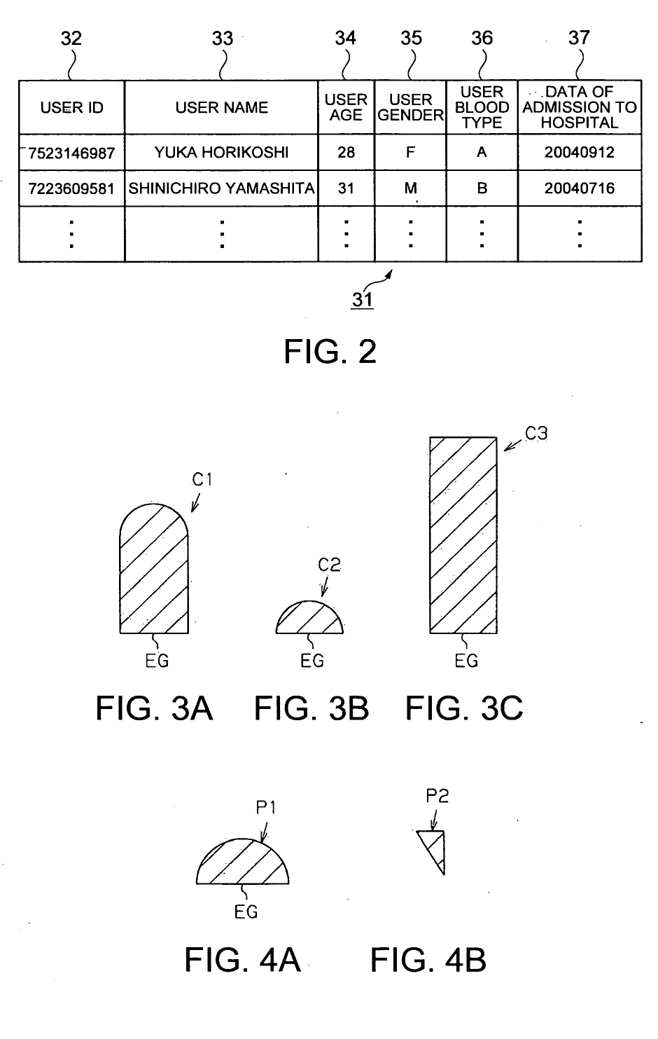

The patient data storage section 21 is storing patient data 31 for every patient. As shown in FIG. 2, the patient data 31 in this example includes a user ID 32, a user name 33, a user age 34, a user gender 35, a user blood type 36, a date of admission to hospital 37, and others. The user ID 32 is an identification number of identifying a patient being a matching object, and in this example, the user ID is 10-digit numbers of 0 to 9 with various combinations.. Such information of the user name 33, the user age 34, the user gender 35, the user blood type 36, the data of admission to hospital 37, and others are each being text or numerical data.

The prescription data storage section 22 is storing prescription data that is created based on doctors' prescription. This prescription data is entered in relation to the user ID 32, and includes a drug name 38 for patient medication, and a use date 39 of the drug (refer to FIG. 10), for example.

The pattern data storage section 23 is storing a graphics file including therein a graphics pattern of a color ID pattern 110 (refer to FIG. 10). The color ID pattern 110 is a predetermined graphics pattern of a color combination for use for identifying the ID, i.e., user ID 32. The color combination is made based on colors that are respectively set to the numbers of 0 to 9 configuring the user ID 32. The pattern data storage section 23 is storing graphics patterns for formation of such a color ID pattern 110, specifically, graphics patterns for ID matching based on colors set to the numbers (hereinafter, referred to as “matching patterns”), and other graphics patterns for positioning the matching patterns (hereinafter, “positioning patterns”).

The picture data storage section 24 is storing a face picture file storing a patient's face picture 40 (refer to FIG. 10) for use for checking the patient as a matching object. This face picture file is entered in relation to the user ID 32. The face picture 40 is of color picture data, and is stored in the size suitable for printing to the color ID cards 101 and 102.

The format data storage section 25 is storing data about a format (creation format) for use for making the color ID cards 101 and 102. As shown in FIG. 10, with this creation format, the color ID cards 101 and 102 are each printed frameless with the color ID pattern 110 on any one side end surface among the four side ends.

By referring to FIGS. 3A to 4B, described next is the shape of a matching pattern and that of a positioning pattern that form the color ID pattern 110.

FIGS. 3A to 3C are each a schematic diagram showing an exemplary matching pattern. Specifically, FIG. 3A shows a length-long matching pattern C1 with a circular end, FIG. 3B shows a half-round matching pattern C2, and FIG. 3C shows a rectangular matching pattern C3. FIGS. 4A and 4B are each a schematic diagram showing an exemplary positioning pattern. Specifically, FIG. 4A shows a half-round positioning pattern P1, and FIG. 4B shows an inverted-triangle positioning pattern P2. As described in the foregoing, these patterns are stored in the pattern data storage section 23. The matching patterns C1 to C3 and the positioning patterns P1 are each having an end surface EG being flat and linear. The end surfaces EG each serve as a mating end surface at the time of ID matching using the color ID pattern 110 printed to both the color ID cards 101 and 102. The details will be given later.

The color ID pattern 110 is formed using one of the matching patterns C1 to C3, and either the positioning pattern P1 or P2. That is, the matching pattern C1 (or C2 or C3) to be used to form the color ID pattern 110 is of the same graphics for the 10-digit numbers of the user ID 32. The combination of the matching pattern and the positioning pattern will be determined by a pattern setting register 92 (refer to FIG. 8), which will be described later.

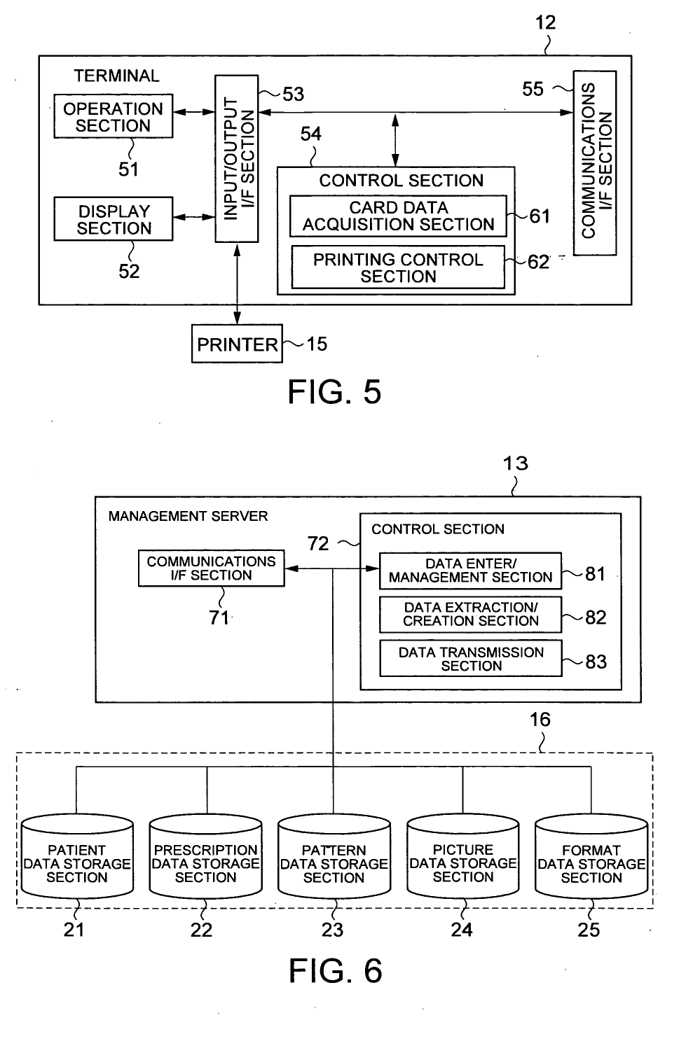

By referring to FIGS. 5 and 6, described next is the function configuration of the terminal 12 and the management server 13 in the card making system 1 of this embodiment.

FIG. 5 is a schematic block diagram showing the hardware configuration of the terminal 12.

The terminal 12 is configured to include an operation section 51, a display section 52, an input/output I/F (interface, this is applicable to below) section 53, a control section 54, and a communications I/F section 55.

The input/output I/F section 53 exercises control over data exchange with the operation section 51 and the display section 52, and by extension, with the printer 15. The operation section 51 is configured by a keyboard 51a, a mouse 51b (both refer to FIG. 1), or others for use for input of various types of data and commands. The display section 52 is configured by a monitor 52a (refer to FIG. 1) exemplified by CRT or LCD. The display section 52 displays thereon a screen for processing, a screen for the processing result, and others. The communications I/F section 55 is in charge of communications control between the terminal 12 and the network 14 via communications equipment, e.g., router, that is not shown.

The control section 54 is configured by a CPU, ROM, RAM, and others, all of which are not shown. In the functional concepts, the control section 54 is configured to include a card data acquisition section 61, and a printing control section 62. A program for implementing processes in such functional sections 61 and 62 is stored in the ROM, for example, and in accordance with the program stored in the ROM, the CPU goes through processes while utilizing the RAM as a working area, e.g., buffer.

The card data acquisition section 61 is a processing section of acquiring image data from the management server 13. The image data is of the two color ID cards 101 and 102 to be created (printed) on the label sheet 100, and is hereinafter referred to as card data. More in detail, the card data acquisition section 61 selects a target patient for making the color ID cards 101 and 102, and forwards the user ID 32 of the selected patient to the management server 13. The card data acquisition section 61 then acquires from the management server 13 the card data of the color ID cards 101 and 102 including the color ID pattern 110 created based on the user ID 32.

The printing control section 62 is a processing section of converting the card data acquired by the card data acquisition section 61 into printing data for use by the printer 15, and forwarding the resulting printing data to the printer 15. The printer 15 performs printing to the label sheet 100 based on the printing data provided by the printing control section 62 so that the color ID cards 101 and 102 are made using the label sheet 100. Note here that, as an alternative function configuration, the printing control section 62 may be provided on the side of the printer 15, and the card data received by the terminal 12 may be converted into printing data on the side of the printer 15.

FIG. 6 is a schematic block diagram showing the hardware configuration of the management server 13.

The management server 13 is configured to include a communications I/F section 71, and a control section 72. The communications I/F section 71 is in charge of two-way communications control with the network 14 via communications equipment, e.g., router, that is not shown. The control section 72 is configured by a CPU, ROM, RAM, and others, all of which are not shown. In the functional concepts, the control section 72 is configured to include a data enter/management section 81, a data extraction/creation section 82, and a data transmission section 83. A program for implementing processes in such functional sections 81 to 83 is stored in the ROM, for example, and in accordance with the program stored in the ROM, the CPU goes through processes while utilizing the RAM as a working area, e.g., buffer.

The data enter/management section 81 is a processing section of entering various types of data into the database 16, and managing thus entered data. More specifically, the data enter/management section 81 enters the patient data 31 to the patient data storage section 21, enters the prescription data to the prescription data storage section 22, enters the graphics patterns (matching patterns and positioning patterns) to the pattern data storage section 23, enters the face pictures 40 to the picture data storage section 24, enters the creation formats to the format data storage section 25, and changes or deletes the entered data, for example.

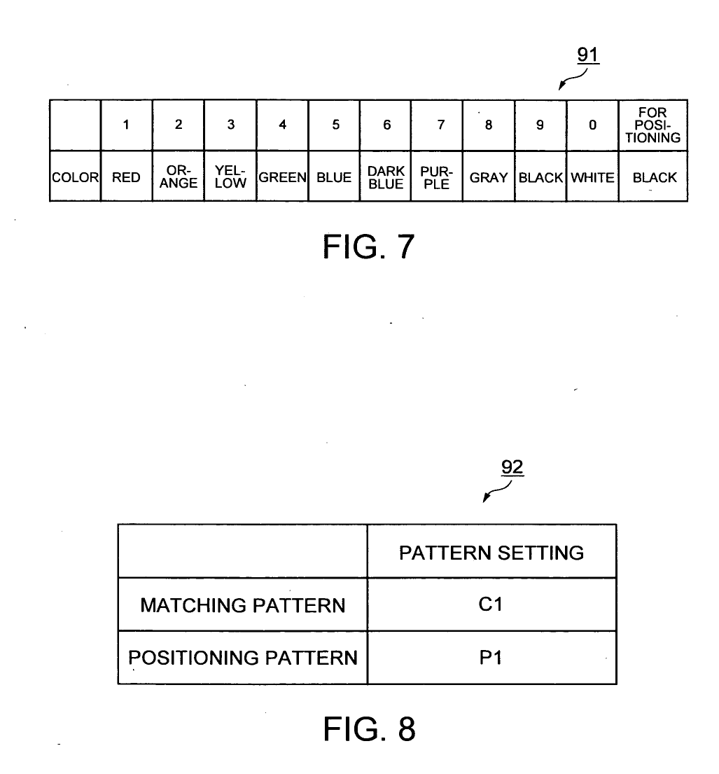

The data enter/management section 81 includes a color setting register 91 (FIG. 7) and a pattern setting register 92 (FIG. 8). The color setting register 91 is in charge of color setting to the color ID pattern 110, and the pattern setting register 92 is in charge of pattern setting thereto. The data enter/management section 81 makes settings to the registers 91 and 92, i.e., colors and patterns of the matching and positioning patterns in the color ID pattern 110.

As shown in FIG. 7, the color setting register 91 is set with colors for the respective numbers of 0 to 9 of the user ID 32, i.e., matching patterns of the respective numbers, and a color for the positioning pattern. The colors for the numbers are so set as to be different from one another.

In this example, the numbers of 0 to 9 are respectively assigned with white, red, orange, yellow, green, blue, dark blue, purple, gray, and black. This color combination is not restrictive, and it is desirable to give a thought to make the color combination easy to distinguish even for people suffering from color perception difficulty, i.e., color combination easy for color discrimination in terms of category. It is generally understood that the people suffering from color perception difficulty are responsive, if anything, to a difference of color lightness or chroma all the more because of their difficulty of hue discrimination, and have no specific problem for contrast discrimination of any similar colors. It is thus considered preferable, at the time of color assignment, not to combine together any colors similar in lightness or chroma, or any colors similar in lightness but different in hue. In other words, the preferable color combination is of the same hue but different in lightness, e.g., even when colors assigned to ten-digit numbers are all monochrome, the colors are changed in lightness to represent 10 levels of color difference. In consideration of the fact that human eyes logarithmically perceive brightness, the lightness is preferably specified by value not with an arithmetic progression, e.g., 10%, 20%, 30%, 40%, and others, but with a geometric progression, e.g., 10%, 14.1%, 20%, 28.2%, and others. By giving a thought to color combination as such, even people suffering from color perception difficulty can easily discriminate the color ID pattern 110 by color so that the possible occurrence of any erroneous matching can be favorably reduced.

As shown in FIG. 8, the pattern setting register 92 is set with graphics patterns for the color ID pattern 110, i.e., a matching pattern and a positioning pattern. Such graphics patterns are those selected from graphics files stored in the pattern data storage section 23. In this example, the matching pattern Cl and the positioning pattern P1 are selected from the pattern data storage section 23 for setting.

The data extraction/creation section 82 is a processing section of extracting from the database 16 any data needed to make the color ID cards 101 and 102 in response to a command coming from the terminal 12 to acquire card data, and creating card data based on thus extracted data.

To be more specific, based on the user ID 32 received from the terminal 12, the data extraction/creation section 82 extracts from the patient data storage section 21 data about a specific patient that has been entered in the patient data 31, i.e., the user name 33, the user age 34, the user gender 35, the user blood type 36, and the date of admission to hospital 37. The data extraction/creation section 82 also extracts from the prescription data storage section 22 data that has been entered in the prescription data of the patient, i.e., the drug name 38, and the use date 39 of the drug. The data extraction/creation section 82 also extracts from the picture data storage section 24 the face picture 40 of the patient, and extracts from the format data storage section 25 a creation format.

The data extraction/creation section 82 also extracts from the pattern data storage section 23 the matching pattern C1 and the positioning pattern P1 that have been set in the pattern setting register 92. The data extraction/creation section 82 then creates the color ID pattern 110 of the matching pattern C1 and the positioning pattern P1 with a color combination for the user ID 32 of the patient. Such pattern creation is based on the colors that have been set in the color setting register 91. Assuming that the user ID 32 of the patient is “7523146987”, the color combination of 10 colors for the matching pattern C1 is “purple, blue, orange, yellow, red, green, dark blue, black, gray, and purple” based on the colors that have been set in the color setting register 91. The positioning pattern P1 is “black”.

The data extraction/creation section 82 then creates card data for making the color ID cards 101 and 102 on the label sheet 100 based on the creation format. As shown in FIG. 10, the color ID card 101 includes data about the patient, i.e., the user name 33, the user age 34, the user gender 35, the user blood type 36, the date of admission to hospital 37, the face picture 40, and the color ID pattern 110. The color ID card 102 includes data about the patient, i.e., the user name 33, the drug name 38, the use date 39 of the drug, the face picture 40, and the color ID pattern 110.

The data transmission section 83 is a processing section of forwarding to the terminal 12 the card data about the color ID cards 101 and 102 created by the data extraction/creation section 82 as such.

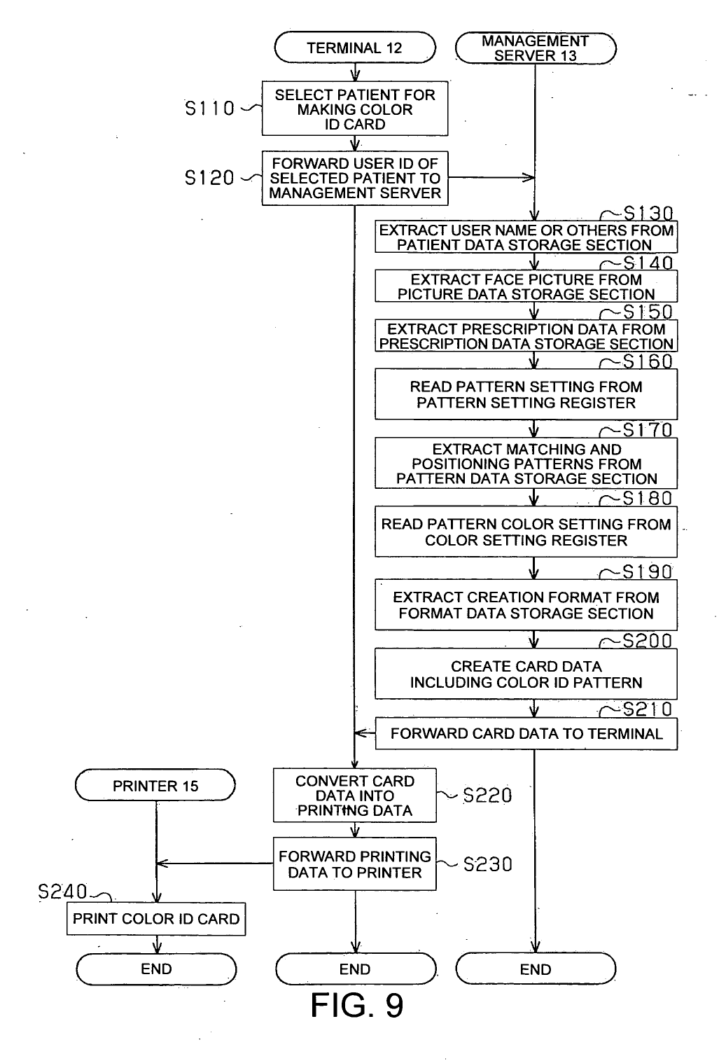

By referring to FIG. 9, described next is the procedure of a card making process in the card making system 1 of this embodiment.

FIG. 9 is a flowchart of the card making process.

In step S101, a target patient is selected for making the color ID cards 101 and 102. In step S102, the terminal 12 then issues a command for card data acquisition by forwarding the user ID 32 of the selected patient to the management server 13.

After receiving the user ID 32 from the terminal 12, the management server 13 extracts from the database 16 any data needed to create card data based o the user ID 32. That is, in step S130, the patient data 31, e.g., the user name 33 and others, is extracted from the patient data storage section 21, and in step S140, the face picture 40 of the patient is extracted from the picture data storage section 24. In step S150, the prescription data of the patient, e.g., the drug name 38 or others, is extracted from the prescription data storage section 22. Then in step S160, the pattern setting of the color ID pattern 110 is read from the pattern setting register 92, and in step S170, the matching pattern C1 and the positioning pattern P1 having been set to the pattern setting register 92 are extracted from the pattern data storage section 23. In step S180, the color setting of the color ID pattern 110 is read from the color setting register 91, and the color ID pattern 110 for the user ID 32 is created. In step S190, the creation format is extracted from the format data storage section 25, and in step S200, based on the creation format, card data is created for the color ID cards 101 and 102 both including the color ID pattern 110. In step S210, the resulting card data is forwarded to the terminal 12.

After receiving the card data from the management server 13, in step S220, the terminal 12 converts the card data into printing data for use by the printer 15, and in step S230, the resulting printing data is forwarded to the printer 15.

In step S240, the printer 15 applies a printing process to the label sheet 100 based on the printing data provided by the terminal 12. The color ID cards 101 and 102 are thus created for the patient selected in step silo.

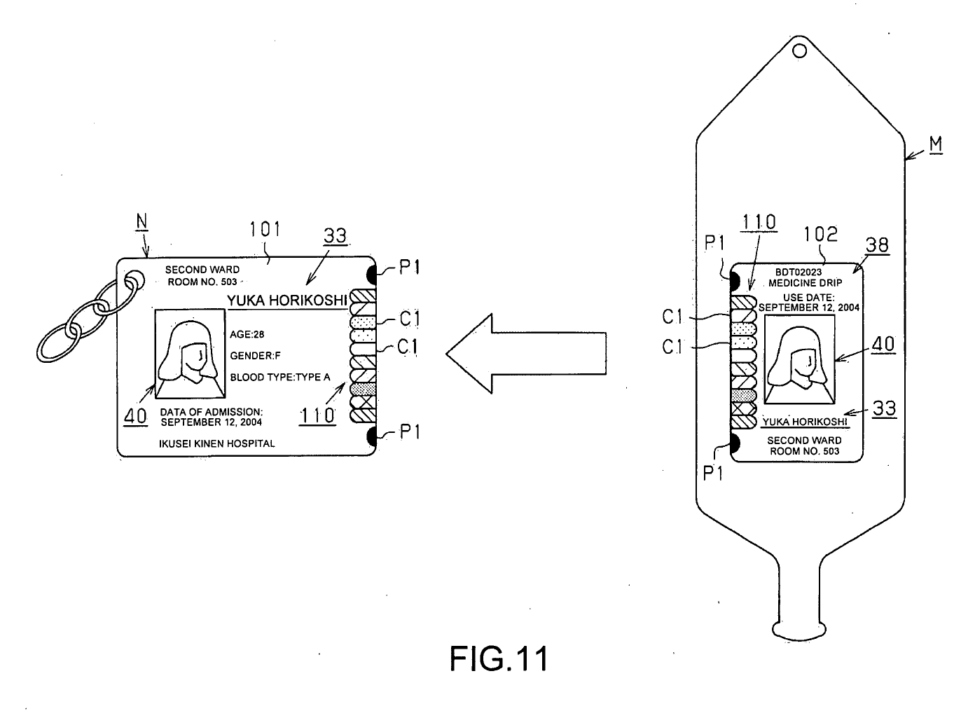

By referring to FIGS. 10 and 11, described next are the characteristics of the color ID cards 101 and 102 made by the card making system 1 of this embodiment, and a method for identifying the patient using the cards 101 and 102.

FIG. 10 is a schematic diagram showing an exemplary printing result of the color ID cards 101 and 102 on the label sheet 100. FIG. 11 is a schematic diagram exemplarily showing how the cards 101 and 102 are to be used in real world.

The color ID card 101 is a label to be affixed to a name card N (FIG. 11) or others for use for identifying the patient. The name card N is provided to the patient's bed, and is printed with the user name 33, the face picture 40, the color ID pattern 110, or others. The color ID card 102 is a label to be affixed to a drug package M (FIG. 11) or others, and is printed with the drug name 38, the user name 33, the face picture 40, the color ID pattern 110, or others. That is, the color ID cards 101 and 102 are both printed with the user name 33 in common, the face picture 40, and the color ID pattern 110. The color ID pattern 110, i.e., the matching pattern C1 and the positioning pattern P1, is printed frameless on the end surfaces of the cards 101 and 102 to be symmetrical to each other.

When doctors or nurses give medical treatment to the patient, the ID matching is made, i.e., the patient is authenticated, using the color ID pattern 110 of the color ID card 101 affixed to the name card N and that of the color ID card 102 affixed to the drug package M.

More in detail, for ID matching, the color ID card 101 (name card N) serving as a matching card is paired up with the color ID card 102 (drug package M) serving as a to-be-matched card at their end surfaces, and the cards are aligned at their matching positions using their positioning patterns P1. Such card positioning is so performed that a circular pattern is formed between the color ID cards 101 and 102 when their positioning patterns P1 are paired up at their mating end surfaces, i.e., end surfaces being flat and linear.

Once such card positioning is done using the positioning patterns P1, the matching patterns C1 agree with each other in shape at their mating end surfaces, i.e., end surfaces being flat and linear, between the color ID cards 101 and 102 specifically at their corresponding number positions. Accordingly, the matching patterns C1 of the color ID cards 101 and 102 become a single pattern therebetween. That is, the matching patterns C1 of the color ID card 101 serving as a matching card is linked in line for all of the colors with the matching patterns C1 of the color ID card 102 serving as a to-be-matched card so that a single length-long pattern is formed at their mating end surfaces.

In such a state of the matching patterns C1 of the color ID cards 101 and 102 being agreed with each other on a color (number) basis, ID matching is made whether the matching patterns C1 are sharing the same 10 colors between the color ID cards 101 and 102. Though such ID matching, a determination is made whether the pharmaceutical drug about to be given to the patient is correctly right for him or her. At the time of such ID matching, using also the user name 33 and the face picture 40 printed to both the color ID cards 101 and 102 for patient authentication can reduce the possible occurrence of any erroneous matching to a further degree.

As described in the foregoing, the following effects can be achieved in this embodiment.

1. The color ID pattern 110 is formed by combining colors assigned to 10-digit numbers of the user ID 32, and the resulting color ID pattern 110 is printed both on the color ID cards 101 and 102, i.e., matching and to-be-matched cards. That is, the numbers of the user ID 32 are replaced with the color ID pattern 110 of a color combination, and for matching, the color ID pattern 110 of the card 101 is compared with that of the card 102 to determine their agreement in color. This enables to determine the agreement/disagreement in color at a glance without visually follow the numbers. This also reduces the possible occurrence of any erroneous matching by comparing graphics patterns of the same color. In this embodiment, the color ID pattern 110 is of a combination of colors corresponding to a unique combination of numbers of the user ID 32 so that the resulting color ID pattern 110 will never share the same color combination with any other users. As such, utilizing such color ID patterns can preferably reduce the possible occurrence of any erroneous matching. This configuration is surely not requiring any additional equipment such as barcode reader for use for matching.

2. The matching pattern C1 of the color ID card 101 is symmetrical to that of the color ID card 102. This thus enables matching not only based on color combination but also based on whether graphics patterns are the same or not so that the possible occurrence of any erroneous matching can be further reduced.

3. The matching patterns C1 (10 colors) of the cards 101 and 102 are flat and linear at their mating end surfaces to be paired up together, and the end surfaces opposite to the mating end surfaces are formed not flat and linear, e.g., circular in this example. This configuration enables to preclude the possibility of making matching with the wrong matching pattern orientation.

4. The matching patterns C1 are printed frameless on the end surfaces of the color ID cards 101 and 102. Printing patterns on the end surfaces of the cards as such enables matching with two matching patterns C1 of the cards 101 and 102 placed closer to each other. This accordingly eases to check any agreement in color, thereby favorably reducing the possible occurrence of any erroneous matching to a further degree.

5. The positioning pattern P1 is printed to both of the cards 101 and 102 for use to align the matching positions, i.e., to align the matching patterns C1 between the color ID cards 101 and 102 on a number basis. This preferably precludes the possibility of making a wrong determination about agreement/disagreement in color with the misaligned matching patterns C1 between the cards 101 and 102, and the possibility of erroneously making matching.

6. In addition to the color ID pattern 110, i.e., the matching patterns C1 and the positioning pattern P1, the color ID cards 101 and 102 are both printed also with the user name 33 and the face picture 40 of the patient. By authenticating the patient not only based on the color ID pattern 110 but also based on the user name 33 and the face picture 40, the possible occurrence of any erroneous matching can be reduced to a greater degree.

7. The color ID cards 101 and 102, i.e., the matching card and the to-be-matched card, are each made with a label sheet 100 having an adhesive sticker surface. This offers greater versatility to the cards 101 and 102 each printed with the color ID pattern 110.

Modified Examples of First Embodiment

The above-described first embodiment can be modified as below for application.

### MODIFIED EXAMPLE 1

In the card making system 1 of the first embodiment, the functions of the terminal 12 and the functions of the management server 13 can be implemented in a single piece of computer, e.g., only the terminal 12. The card making system 1 is also implemented by installing a program, i.e., card making program, for making the color ID cards 101 and 102 to each of a plurality of computers. The card making program in the first embodiment and the modified example 1 is stored, for distribution, in portable media exemplified by flexible disks or CD-ROMs, a main or secondary storage unit of any other network-connected computing machines, or others. After distributed, the program is loaded for execution from a portable medium directly into a main storage unit of a computing machine, or copied or installed to a secondary storage unit from a portable medium before loaded into a main storage unit. When the program is distributed after stored in any other network-connected equipment, the program is copied or installed into a secondary storage unit after provided by the equipment over the network, and then loaded to a main storage unit for execution.

### MODIFIED EXAMPLE 2

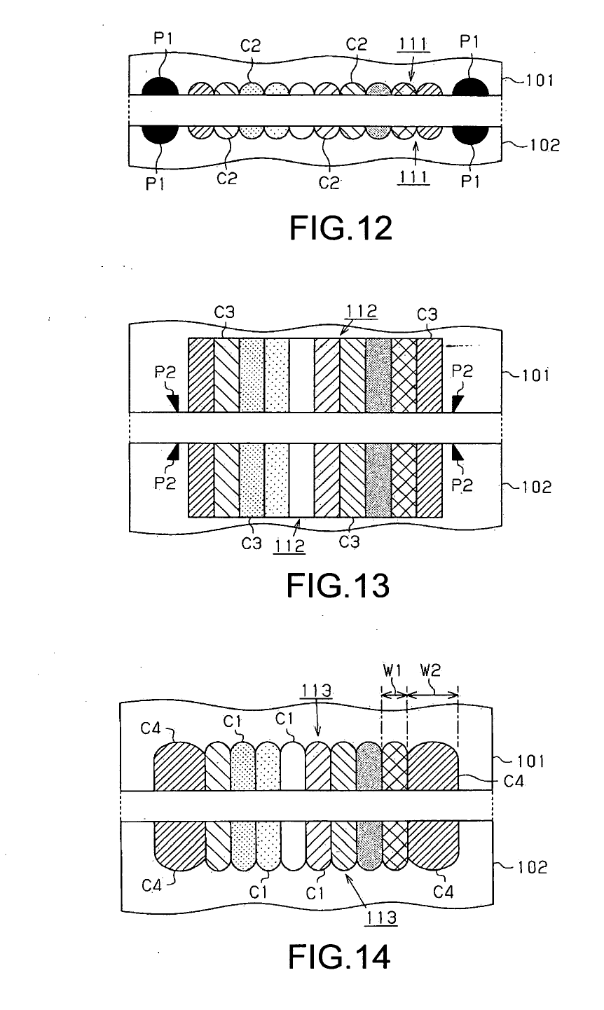

The color ID pattern 110 to be printed to both the color ID cards 101 and 102 may be a color ID pattern 111 of FIG. 12. This color ID pattern 111 is the one including the matching pattern C2 (FIG. 3B) and the positioning pattern P1 (FIG. 4A) stored in the pattern data storage section 23. That is, this color ID pattern 111 carries therein the half-round matching pattern C2 so that the printing area of the color ID pattern 111 can be less than the case with the matching pattern C1. This is considered advantageous when the color ID cards 101 and 102 are to be made in small size.

### MODIFIED EXAMPLE 3

The color ID pattern 110 to be printed to both the color ID cards 101 and 102 may be a color ID pattern 112 of FIG. 13. This color ID pattern 112 is the one including the matching pattern C3 (FIG. 3C) and the positioning pattern P2 (FIG. 4B) stored in the pattern data storage section 23. That is, this color ID pattern 112 carries therein the matching pattern C3 that is longer in length than the matching pattern C1, thereby easing color discrimination. This thus can reduce the possible occurrence of any erroneous matching.

### MODIFIED EXAMPLE 4

The color ID pattern 110 to be printed to both the color ID cards 101 and 102 may be a color ID pattern 113 of FIG. 14. This color ID pattern 113 includes the matching pattern C1 and a newly-provided matching pattern C4 having a width W2 that is wider than a width W1 of the matching pattern C1. That is, the color ID pattern 113 is formed only by the matching patterns C1 and C4 without using the positioning patterns P1 and P2. In this example, in the numbers of the user ID 32, the first and last digits are assigned with the matching pattern C4. Assuming that the user ID 32 is “7523146987”, the first and last numbers “7” are assigned with the matching pattern C4. In this manner, the matching patterns C4 at both ends serve as the positioning pattern. Note that assigning the matching pattern C4 to the first and last digits of the user ID 32 is not surely restrictive. Exemplified here is the case of using the two matching patterns C1 and C4, but alternatively, any other matching pattern with a different width may be newly provided to form the color ID pattern 113 including three or more matching patterns. The resulting color ID pattern 113 can also achieve the similar effects as the first embodiment.

### MODIFIED EXAMPLE 5

The matching patterns C1 of the color ID pattern 110 are not necessarily placed closely adjacent to one another. That is, the matching patterns C1 may be placed one another with a predetermined space therebetween.

### MODIFIED EXAMPLE 6

The color ID pattern 110, i.e., the matching pattern C1 and the positioning pattern P1, to be printed to both the color ID cards 101 and 102 is not necessarily be symmetrical. Alternatively, the color ID cards 101 and 102 may be printed with each different matching pattern, e.g., the color ID card 101 serving as a matching card is printed with the matching pattern C1 (FIG. 3A), and the color ID card 102 serving as a to-be-matched card 102 may be printed with the matching pattern C2 (FIG. 3B). With this being the case, however, the pattern setting is so made that the matching patterns of the color ID cards 101 and 102 agree in shape (width) on a number basis at least on their mating end surfaces. This is aimed to preclude the possibility of erroneously making matching. That is, it is sufficient if the matching patterns can be compared in color for matching between the cards 101 and 102.

### MODIFIED EXAMPLE 7

The numbers (0 to 9) of the user ID 32 may be set with each different matching pattern, i.e., the numbers are assigned with each different matching pattern (some may be the same) in the color ID pattern. For example, the number “0” may be set with the matching pattern C1, the number “1” with the matching pattern C2, and the number “2” with the matching pattern C3. Such a setting enables matching check not only based on color ID pattern combination but also based on whether graphics patterns are the same or not, thereby favorably reducing any erroneous matching to a further degree.

### MODIFIED EXAMPLE 8

The color ID pattern 110 is not necessarily printed on the end surfaces of the color ID cards 101 and 102. To ease the check operation using colors, however, it is preferable to print frameless the color ID pattern 110 on the end surface of at least one of the cards 101 and 102. That is, by printing frameless the color ID pattern on the end surface of either of the cards, the card printed with the pattern is placed over the remaining card so that their color ID patterns 110 can be brought closer to each other for matching. This thus favorably reduces the possible occurrence of any erroneous matching. In view thereof, although the cards 101 and 102 are both printed frameless on their end surfaces in the above embodiment, alternatively, the color ID pattern 110 may be printed on the end surface of the color ID card 101 (the name card N), and the color ID pattern 110 may be printed inside of the color ID card 102 (the drug package M).

### MODIFIED EXAMPLE 9

The mating end surfaces of the matching patterns and positioning patterns are not necessarily be flat and linear.

### MODIFIED EXAMPLE 10

In the above embodiment, the color ID cards 101 and 102 are both printed with the color ID pattern 110, the user name 33, and the face picture 40. This is not restrictive, and the cards 101 and 102 may be printed at least with the color ID pattern 110. The user name 33 and the face picture 40 are those printed for the purpose of reducing the possible occurrence of any erroneous matching. On the other hand, information to be printed to both the color ID cards 101 and 102 is not restrictive to the color ID pattern 110, the user name 33, the face picture 40, but any other information, e.g., the user age 34 or the user gender 35, may be printed.

### MODIFIED EXAMPLE 11

The label sheet 100 is not the only option for a printing medium to be printed with the color ID cards 101 and 102, and any other type of recording paper with no adhesive sticker surface will also do.

### MODIFIED EXAMPLE 12

In the above embodiment, the card data is created on the side of the management server 13. Alternatively, any data extracted from the database 16 may be forwarded to the terminal 12, and the card data may be created on the side of the terminal 12.

### MODIFIED EXAMPLE 13

In the above embodiment, the color ID cards 101 and 102 are specifically used in hospitals. This is surely not the only option, and the cards are widely applicable whenever person authentication is required.

### MODIFIED EXAMPLE 14

In the above embodiment, a matching target is a patient being a human being, and the patient is authenticated using the color ID pattern 110 being a combination of colors respectively corresponding to the numbers of his or her user ID 32 (identification number). However, the human being is not the only option for a matching target (matching object in claims). The matching object may be an object, and a color ID pattern being a combination of colors respectively corresponding to the numbers of an object identification number may be used for object matching. Some exemplary applications are described below.

Exemplary Application 1 of Modified Example 14

Assuming that a package delivery company delivers 10 pieces of packages to one addressee, if a color ID pattern corresponding to their package number (identification number) is printed (or labeled) to all a delivery slip (matching side) and the delivering 10 packages (to-be-matched side), the color ID pattern serves well for use for matching between the delivery slip and the packages. Accordingly, the possible occurrence of delivery error can be precluded.

Exemplary Application 2 of Modified Example 14

When the ink in an inkjet printer is little in amount, a color ID pattern corresponding to the product number (identification number) of the ink cartridge is automatically printed to any arbitrary paper. A user brings the resulting paper printed with the color ID pattern (matching side) to a shop selling ink cartridges, and compares the color ID pattern on the paper with others printed (or labeled) on boxes of ink cartridge (to-be-matched side). Accordingly, the possible purchase error can be precluded.

Exemplary Application 3 of Modified Example 14

With filing boxes, when a file once removed from a box is put back to the box, if a color ID pattern corresponding to an identification number of the box is printed (labeled) to both the box (matching side) and the file (to-be-matched side), the color ID pattern serves well for matching between the file and the box. Accordingly, the possible filing error can be prevented.

### Second Embodiment

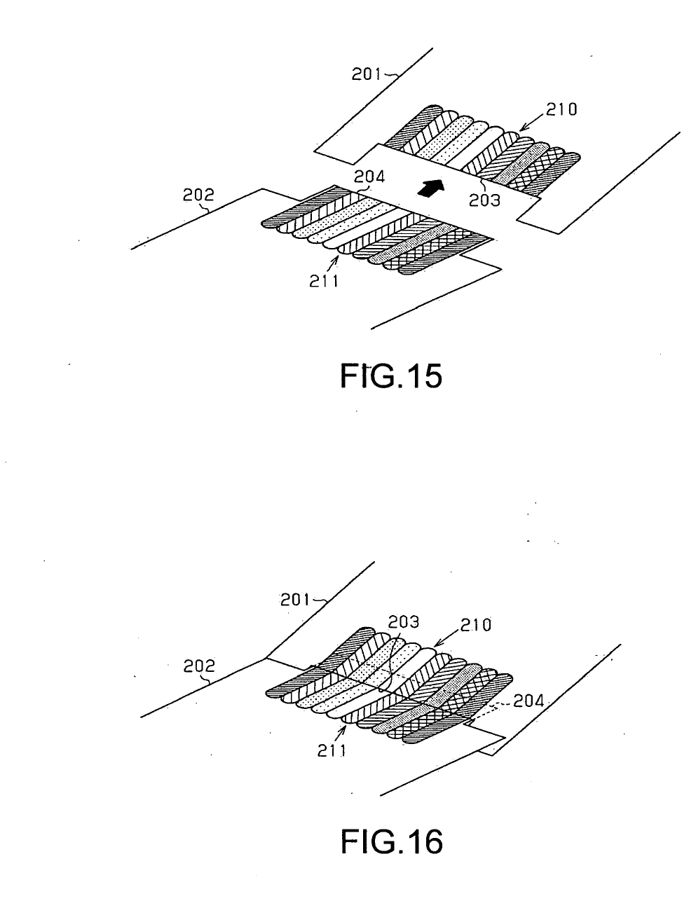

By referring to FIGS. 15 and 16, described next is a second embodiment of the invention.

As shown in FIG. 15, a color ID card 201 of this embodiment is formed with a notch portion 203 at one end, and a color ID card 202 is formed at one end with a convex portion 204 to be inserted into the notch portion 203. Herein, it does not matter on which card (matching or to-be-matched card) the notch portion 203 (or the convex portion 204) will be formed.

A color ID pattern 210 of the color ID card 201 is printed frameless along the end surface of the notch portion 203. In this embodiment, as an example, the color ID pattern 210 is formed using the matching pattern C1 of FIG. 3A. On the other hand, a color ID pattern 211 of the color ID card 202 is printed frameless along the end surface of the convex portion 204, and is longer in length than the color ID pattern 210 (matching pattern C1).

As shown in FIG. 16, with such color ID cards 201 and 202, the matching positions can be aligned using the color ID patterns 210 and 211 by coupling together the cards 201 and 202, i.e., the convex portion 204 of the color ID card 202 is inserted into the notch portion 203 of the color ID card 201. This can preclude the possible occurrence of any erroneous matching resulted from misaligned matching positions with almost certainty. This thus eliminates the need for the positioning patterns in the first embodiment. Moreover, only coupling together the cards 201 and 202 enables matching in this embodiment so that the matching operation can be accordingly eased.

Alternatively, the notch portion 203 may be formed inside of the color ID card 201 as an aperture window, and the insertion position of the convex portion 204 may be provided inside of the color ID card 201 by printing frameless the color ID pattern 210 along the end surface of the aperture window. It does not mean that the notch portion 203 has to be provided at the end portion of the color ID card 201.

In this embodiment, the color ID pattern 211 is not necessarily printed on the end surface of the convex portion 204. That is, in the state that the color ID cards 201 and 202 are coupled together with the convex portion 204 inserted into the notch portion 203, the color ID patterns 210 and 211 may be printed on a coupled part between the cards 201 and 202.

In the second embodiment, the technical scope of the “modified examples of the first embodiment”, i.e., modified examples 1 to 14, can be adopted and combined as required.

### Third Embodiment

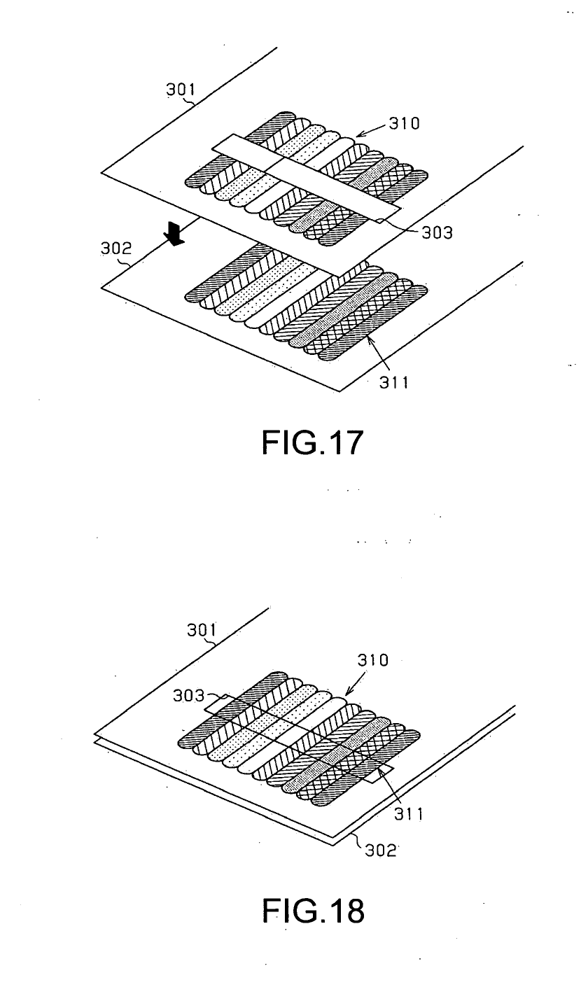

By referring to FIGS. 17 and 18, described next is a third embodiment of the invention.

As shown in FIG. 17, a color ID card 301 has an aperture window 303 formed at where a color ID pattern 310 is printed thereon. The aperture window 303 is used to make visible a color ID pattern 311 to be printed onto the other color ID card 302. Herein, it does not matter on which card (matching or to-be-matched card) the aperture window 303 will be formed.

More in detail, the color ID cards 301 and 302 are of the same shape in this embodiment, and the color ID patterns 310 and 311 are formed (printed) at the same position on the color ID cards 301 and 302, respectively, using the matching pattern of the same shape. To the color ID pattern 310 to be printed on the side of the color ID card 301, the aperture window 303 is formed as if being cut partly (e.g., the center portion).

With the color ID cards 301 and 302 configured as such, as shown in FIG. 18, the color ID card 301 is placed over the color ID card 302 to make the color ID pattern 311 partially visible through the aperture window 303 so that the matching can be made using the color ID patterns 310 and 311. Specifically in this embodiment, for matching making, because the color ID cards 301 and 302 are made in the same shape, their matching positions are automatically aligned by placing the card 301 over the card 302. This thus eliminates the need for the positioning patterns in the first embodiment.

In this embodiment, the color ID cards 301 and 302 can be made in each different shape. The printing positions of the color ID patterns 310 and 311 are not necessarily be the same, and can be arbitrarily set in the cards 301 and 302.

In the third embodiment, the technical scope of the “modified examples of the first embodiment”, i.e., modified examples 1 to 14, can be adopted and combined as required.

### Fourth Embodiment

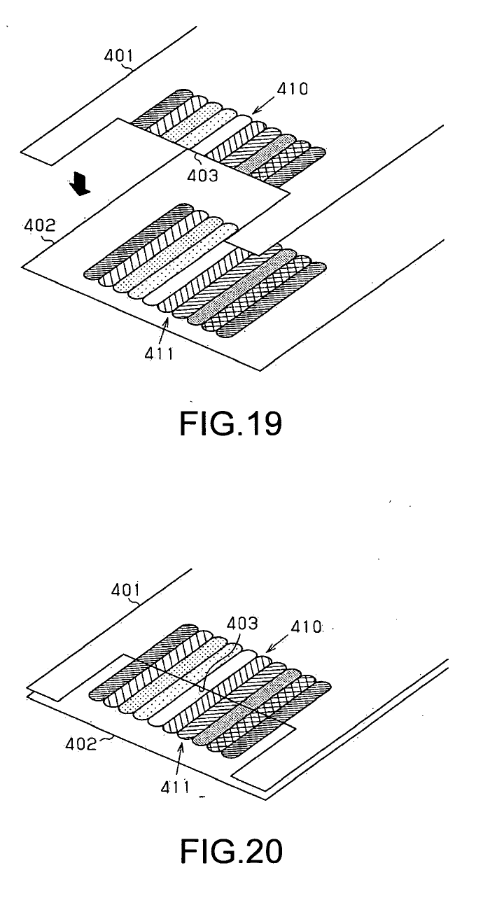

By referring to FIGS. 19 and 20, described next is a fourth embodiment of the invention.

As shown in FIG. 19, a color ID card 401 of this embodiment is formed with a notch window 403 by notching one end side in the width direction toward inside. Along the end surface of this notch window 403, a color ID pattern 410 is printed frameless.

More in detail, the color ID cards 401 and 402 are made in the same shape in this embodiment, and the length of the color ID pattern 410 to be printed on the color ID card 401 is a half of the length of a color ID pattern 411 to be printed on the other color ID card 402. Here, the color ID pattern 410 is printed frameless along the end surface of the notch window 403. Herein, it does not matter on which card (matching or to-be-matched card) the notch window 403 will be formed.

With the color ID cards 401 and 402 configured as such, as shown in FIG. 20, the color ID card 401 is placed over the color ID card 402 to make the color ID pattern 411 partially visible through the notch window 403 so that the matching can be made using the color ID patterns 410 and 411. Specifically in this embodiment, for matching making, because the color ID cards 401 and 402 are made in the same shape, their matching positions are automatically aligned by placing the card 401 over the card 402. This thus eliminates the need for the positioning patterns in the first embodiment.

In this embodiment, the color ID cards 401 and 402 can be made in each different shape. The color ID pattern 411 to be printed to the color ID card 402 can also be printed (printed frameless) on the end surface thereof.

In the fourth embodiment, the technical scope of the “modified examples of the first embodiment”, i.e., modified examples 1 to 14, can be adopted and combined as required.

### Fifth Embodiment

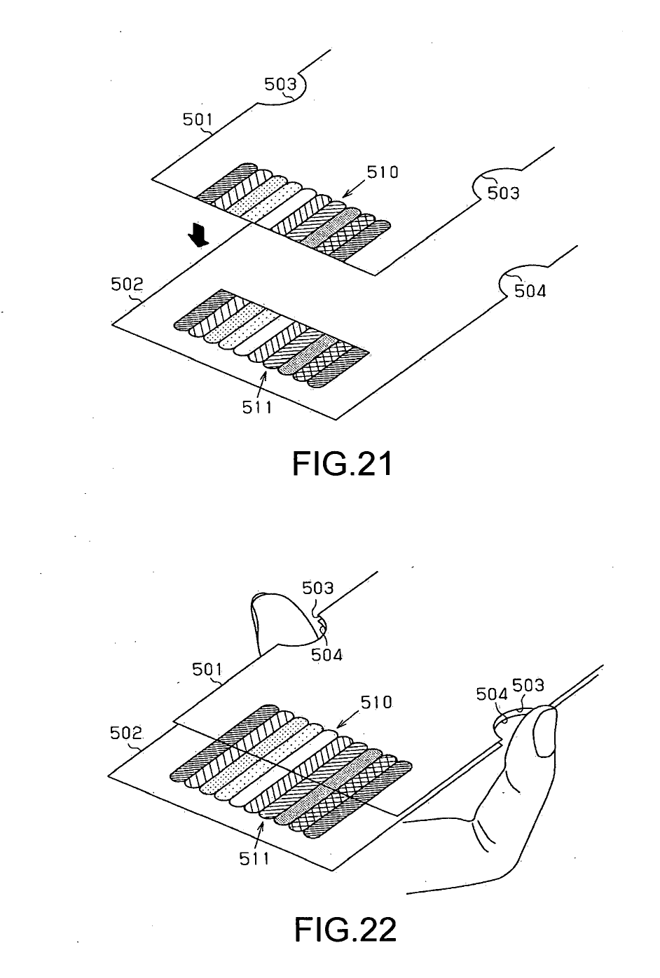

By referring to FIGS. 21 and 22, described next is a fifth embodiment of the invention.

As shown in FIG. 21, color ID cards 501 and 502 of this embodiment are formed with notch portions 503 and 504, respectively. These notch portions 503 and 504 are used for aligning the card positions of the color ID cards for matching using color ID patterns 510 and 511 printed on the respective cards.

More in detail, the color ID cards 501 and 502 are in the same shape in this embodiment, and the notch portions 503 and 504 are formed at the respective both ends of the cards 501 and 502 to the positions at which the color ID card 501 is displaced to a certain extent from the color ID card 502.

With such color ID cards 501 and 502, as shown in FIG. 22, the card positions can be aligned and the matching positions can be determined only by aligning the notch portions 503 and 504 with fingers. This thus can preclude the possible occurrence of any erroneous matching resulted from misaligned matching positions with almost certainty, and can ease the matching operation. This surely eliminates the need for the positioning patterns in the first embodiment.

In the fifth embodiment, the technical scope of the “modified examples of the first embodiment”, i.e., modified examples 1 to 14, can be adopted and combined as required.

The entire disclosure of Japanese Patent Application Nos:2005-034641, filed Feb. 10, 2005, 2005-331793, filed Nov. 16, 2005 are expressly incorporated by reference herein.

What is claimed is:

1. A color ID card for color matching, comprising:
a matching card; and
a to-be-matched card for color matching with the matching card, wherein
the matching card and the to-be-matched card are both printed with a color ID pattern that is a combination of colors corresponding to, on a digit basis, an identification number of identifying a matching object.

2. The color ID card according to claim 1, wherein
the color ID pattern of the matching card is of a symmetrical design with the color ID pattern of the to-be-matched card.

3. The color ID card according to claim 1, wherein
at least either the matching card or the to-be-matched card is printed frameless with the color ID pattern on an end surface.

4. The color ID card according to claim 1, wherein
the matching card and the to-be-matched card are each flat and linear on a mating end surface printed with the color ID pattern, and are each not flat and linear on an end surface opposite to the mating end surface.

5. The color ID card according to claim 1, wherein
the color ID pattern is formed using two or more of a graphics pattern varying in width by the digits of the identification number.

6. The color ID card according to claim 1, wherein
the color ID pattern is of the combination of the colors
showing no similarity in lightness and chroma among the digits of the identification number.

7. The color ID card according to claim 1, wherein
the color ID pattern is of the combination of the colors showing a similarity in hue but not in lightness among the digits of the identification number.

8. The color ID card according to claim 1, wherein
the color ID pattern includes a matching pattern being a combination of colors corresponding to the identification number on a digit basis, and a positioning pattern for use for positioning the matching pattern between the matching card and the to-be-matched card.

9. The color ID card according to claim 1, wherein
the matching card and the to-be-matched card are each printed with a picture for use to check the matching object.

10. The color ID card according to claim 1, wherein
the matching card and the to-be-matched card are each created with, as a printing medium, a label sheet having an adhesive sticker surface.

11. The color ID card according to claim 1, wherein
either the matching card or the to-be-matched card is formed with a notch portion, a remaining of the cards is formed with a convex portion that can be inserted into the notch portion, and the color ID pattern is printed on a coupled part of the cards between the notch portion and the convex portion.

12. The color ID card according to claim 3, wherein
either the matching card or the to-be-matched card is formed with a notch portion, a remaining of the cards is formed with a convex portion that can be inserted into the notch portion, and the color ID pattern is printed on a coupled part of the cards between the notch portion and the convex portion.

13. The color ID card according to claim 1, wherein
either the matching card or the to-be-matched card is formed with, at a printing part for the color ID pattern, an aperture window to make visible the color ID pattern printed on the remaining of the cards.

14. The color ID card according to claim 1, wherein
either the matching card or the to-be-matched card is notched at one end in a width direction toward inside to form a notch window, and the color ID pattern is printed frameless on an end surface of the notch window.

15. The color ID card according to claim 1, wherein
the matching card and the to-be-matched card are each formed with a notch portion to align the cards with each other to enable matching using the color ID patterns.

16. The color ID card according to claim 3, wherein
the matching card and the to-be-matched card are each formed with a notch portion to align the cards with each other to enable matching using the color ID patterns.

17. A card making system that makes a color ID card including a matching card and a to-be-matched card for color matching with the matching card, the system comprising:
a unit that sets a color, on a digit basis, to an identification number of identifying a matching object;
a unit that sets a graphics pattern to each of the digits of the identification number;
a unit that forms a color ID pattern by combining the colors and the graphics patterns set to each of the digits of the identification number, and creates image data of the color ID card by laying out the color ID pattern to both the matching card and the to-be-matched card;
a unit that converts the image data into printing data; and
a unit that prints the color ID card onto a predetermined printing medium based on the printing data.

18. A computer-executable program for making a color ID card including a matching card and a to-be-matched card for color matching with the matching card, the program comprising, for computer execution:
a process of setting a color, on a digit basis, to an identification number of identifying a matching object;
a process of setting a graphics pattern to each of the digits of the identification number; and
a process of forming a color ID pattern by combining the colors and the graphics patterns set to each of the digits of the identification number, and creating image data of the color ID card by laying out the color ID pattern to both the matching card and the to-be-matched card.
